(19) United States
(12) Patent Application Publication
(10) Pub. No.: US 2015/0321698 A1
(43) Pub. Date: Nov. 12, 2015

(54) FORMATION OF AN EMERGENCY LANE

(71) Applicant: Robert Bosch GmbH, Stuttgart (DE)

(72) Inventors: Thomas FUEHRER, Stuttgart-Weilimdorf (DE); Christian BRAEUCHE, Hassmersheim-Hochhausen (DE); Oliver PINK, Abstatt (DE)

(21) Appl. No.: 14/409,614

(22) PCT Filed: Apr. 24, 2013
(86) PCT No.: PCT/EP2013/058434

§ 371 Date: Dec. 19, 2014

(30) Foreign Application Priority Data
Jun. 19, 2012 (DE) 10 2012 210 525.3

(51) Int. Cl. B62D 15/02; G08G 1/16; G08G 1/0965

(52) U.S. Cl. CPC B62D 15/029; G08G 1/0965; G08G 1/162; G08G 1/166

(57) ABSTRACT

A supportive method for a driver of a first motor vehicle includes steps of scanning the surroundings of the first motor vehicle, of determining an action instruction to the driver of the first motor vehicle, in order to avoid getting in the way of a second motor vehicle having special authorization, of comparing the action instruction with further motor vehicles in the area of the first motor vehicle and of an outputting of the action instruction to the driver of the first motor vehicle.

### FIELD OF THE INVENTION

The present invention relates to a technique for supporting a driver of a motor vehicle in providing special driving rights of another motor vehicle.

### BACKGROUND INFORMATION

In the case of a traffic jam or slow-moving traffic, the drivers of the participating motor vehicles are required, if necessary, to form a so-called emergency lane, in order to make possible unhindered access, for example, to an emergency vehicle of the police or the fire department or a rescue vehicle. Usually the drivers wait until they notice the approach of a vehicle having a blue blinking light or a fire, police or ambulance siren, in order then to move their own vehicle to one or the other side of the road. In the region that has thus been cleared, an emergency vehicle is then able to use the road that is otherwise blocked by the traffic jam, and thus get to an emergency location which is frequently at the front end of the traffic jam. In the case of two-lane roads it is customary to clear a region between the marked traffic lanes for the rescue vehicle.

In this context, misunderstandings arise again and again between the drivers of the individual motor vehicles as to which driver intends to transfer his motor vehicle to where. The misunderstandings may lead to accidents, which on their part may be further reasons for the continuation of the traffic jam. In addition, a so-called jamming may form, so that a single vehicle which extends into the otherwise cleared region, is not able get out of this region without at least one other motor vehicle moving into the free region. Both symptoms lead to an at least temporary inability to use the region to be cleared by the rescue vehicle.

German document DE 10 2007 028 400 B3 discusses a method in which the approach of a special vehicle entitled to the right of way is determined by its acoustical signature and then, based on a scanning of the local surroundings variables, an action recommendation is determined and output for a driver of a motor vehicle.

### SUMMARY OF THE INVENTION

The present invention is based on the object of providing an improved technique for supporting a driver during the formation of a so-called emergency lane. The object is attained by the present invention using a supportive method, a computer program product and a device having the features of the independent claims. The dependent claims reflect specific embodiments.

A supportive method for a driver of a first motor vehicle includes the steps of scanning the surroundings of the first motor vehicle, of determining action instructions to the driver of the first motor vehicle, in order to avoid it's getting in the way of a second motor vehicle having special authorization, coordinating the action instructions with further motor vehicles in the area of the first motor vehicle and outputting the action instruction to the driver of the first motor vehicle.

It is advantageously possible already to form a special lane or an emergency lane even before a specific demand of the second motor vehicle having special authorization is present or is known. In addition, by the comparison of the action instruction with other, surrounding motor vehicles, a concentrated behavior may be created which supports the rapid, uncomplicated and reliable image of a structure that is required in special situations.

Such a structure especially includes the special lane mentioned above or the emergency lane.

In one specific embodiment, a digital message is received which relates to the approach of the second motor vehicle. The digital message may include, in particular, further information on a current position, for example, and a planned emergency location or a planned route of the second motor vehicle. This information may be correlated with a position of the first motor vehicle, in order to be able to output the action instructions sufficiently early. By using a digital message, the determination of the action instruction may be begun already before the driver is able, with his own senses, to notice the approach of the second motor vehicle. In particular, an acoustical determination of the second motor vehicle may be avoided, which in the nature of things is subject to errors, and in addition has to rely on the second motor vehicle to emit an identifiable acoustical signal.

In one specific embodiment, the method also includes the detection of a threatening, or already existing traffic jam situation in the region of the first motor vehicle. On the one hand, the output of an action instruction in normally flowing traffic may be suppressed thereby, and on the other hand, the action instruction may already be determined before an actual demand or the pointing out of an approaching second motor vehicle having special authorization is known. In one specific embodiment, the determined action instruction may be held back until such a pointing out has occurred, and in another one the action instruction may be given directly, in order to be able to implement a foresighted behavior.

The action instruction may be purely informal, and presented to the driver of the first motor vehicle acoustically, optically or haptically. In another specific embodiment, the directional control or the motion control of the first motor vehicle may be actively influenced, in order to implement or support the action instruction. For example, during slow travel or at a standstill, a steering intervention may take place which indicates to the driver of the first motor vehicle in which direction he is supposed to remove his motor vehicle from the special lane.

In one specific embodiment, which in particular is able to be combined with the previously named specific embodiment, the close range of the first motor vehicle may be scanned, in order to carry out a determination of a local travel situation based on the scanning and an adaptation of the action instruction to the travel situation. If, for instance, in the immediate surroundings of the first motor vehicle, an obstacle is detected which would counter the previously determined action instruction, the first action instruction may be suppressed. In its place, a second action instruction may be determined, which takes the obstacle into account.

A computer program product according to the present invention includes program code for carrying out the described method when the computer program product is run on a processing device or stored on a computer-readable data carrier.

A supportive method for a driver of a first motor vehicle, according to the present invention, includes a scanning device for scanning the surroundings of the first motor vehicle, a processing device for determining an action instruction to the driver of the first motor vehicle, in order to avoid getting in the way of a second motor vehicle having special authorization, a data interface for comparing the action instruction with further motor vehicles in the area of the first motor vehicle and an output device for outputting the action instruction to the driver of the first motor vehicle.

The device may advantageously be integrated with one or more devices onboard the motor vehicle, so that networking is possible with systems already installed onboard the first motor vehicle.

In a further specific embodiment, the processing device may be a portable device that is removable from a first motor vehicle. This device may especially include a portable computer or a telephone having additional functions (smart phone). In this case, the portable device may be connected, which may use a wireless data interface, to further devices onboard the motor vehicle. The portable device may itself include further elements which are usable for the improved determination of the action instruction, for instance, a navigation unit, a memory for map data, an accelerometer or an inertial sensor. These elements may particularly be used for determining a driving state of the first motor vehicle.

In a further specific embodiment, there is also included a receiving device for data from a merger of processing devices that are not defined in greater detail. This particularly enables the data technology connection of the processing device with a so-called cloud. A social network, just as a free information service or an information service with costs, may be used to obtain method-relevant parameters, particularly information on an impending or existing traffic jam in the area of the first motor vehicle, and information on the existence of a need for an emergency lane.

The present invention will now be described more accurately with reference to the accompanying figures.

### BRIEF DESCRIPTION OF THE FIGURES

FIG. 1 shows a device for supporting a driver.

FIG. 2 shows an exemplary emergency lane formed by a plurality of motor vehicles.

FIG. 3 shows a flow chart of a method for supporting the driver of FIG. 1.

### DETAILED DESCRIPTION

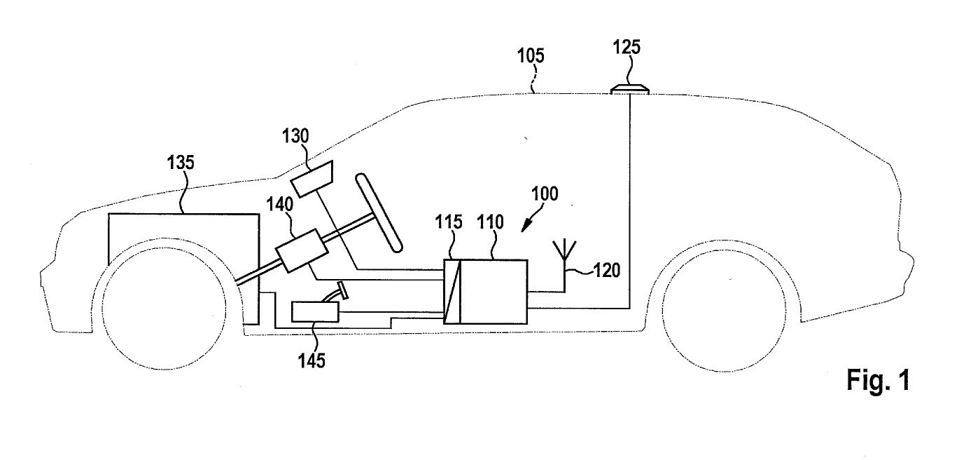

FIG. 1 shows a device 100 for supporting a driver of a motor vehicle 105. Device 100 includes a processing device 110, which is connected to one or more devices onboard motor vehicle 105, using a first interface 115. Processing device 110 is also connected to a second interface 120, which permits a wireless exchange of information with a device outside motor vehicle 105. In one specific embodiment, interface 120 is able to be connected by data technology with a computer network, a telephone provider, another motor vehicle or a network of a plurality of motor vehicles. Second interface 120 may be carried out integrated with device 100, or be situated onboard motor vehicle 105 and connected to processing device 110 using first interface 115.

In one specific embodiment, a positioning device 125 is provided, which may also be carried out integrated with device 100, or be situated onboard motor vehicle 105 and connected to processing device 110 using first interface 115. In addition or alternatively, further information sources or sensors may be able to be connectible to processing device 110, especially an inertial sensor for determining a motion of motor vehicle 105, a magnetic field sensor for determining an alignment of motor vehicle 105, a yaw rate sensor for determining a rotational speed of motor vehicle 105 or a data bank for acquiring map data of the surroundings of motor vehicle 105. Device 100 may particularly be implemented in the form of a portable unit that is removable from motor vehicle 105. The portable unit may especially include a portable computer (lap top) or a telephone having additional functions (smart phone).

Of systems of motor vehicle 105, which are able to be connected in an exemplary manner using first interface 115 and processing device 110, an operating device 130, a drive motor 135, a steering actuator 140 and a brake system 145 are shown. Operating device 130 for the interaction with the driver of motor vehicle 105 may make possible an optical, acoustical or haptic interaction with the driver. In an alternative specific embodiment, operating device 130 may also be included directly by device 100, particularly if the latter is executed to be removable from motor vehicle 105. Things are different with drive motor 135 and brake system 145, which should be classed with motor vehicle 105, and which are able to be influenced by device 100 in order to influence the motion of motor vehicle 105. In a similar manner, the directional steering of motor vehicle 105 may be influenced via steering actuator 140.

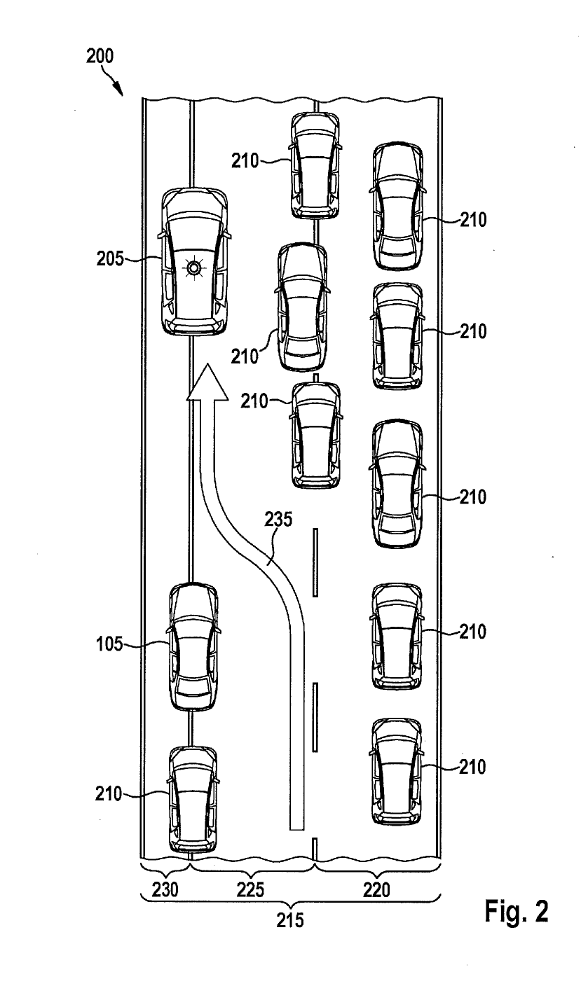

FIG. 2 shows a road situation 200, in which, besides first motor vehicle 105 of FIG. 1, a second motor vehicle 205 is participating, as well as a multiplicity of additional motor vehicles 210.

A road 215 includes a right traffic lane 220 and a left traffic lane 225 and a blocked lane 230. The flow of motor vehicles 105 and 210 on road 215 is impaired, for there is slow-moving traffic, traffic at walking speed or a traffic jam. The second motor vehicle 205 may be a motor vehicle having a blue special signal, particularly a rescue vehicle or an emergency vehicle of the police, the fire department or of a technical aid organization. A motor vehicle having yellow blinking light may also be involved, particularly a roadside assistance vehicle, a snow-removal truck or a construction site truck.

In order to enable second motor vehicle 205 to travel on road 215 in spite of the existing traffic situation, drivers of motor vehicles 105, 210 are required to form a so-called emergency lane 235. In the lower area of the illustration of FIG. 2, emergency lane 235 runs essentially between vehicles of right traffic lane 220 and left traffic lane 225, while in the upper area of the illustration of FIG. 2 emergency lane 235 runs to the left of the vehicles of both traffic lanes 220, 225. The driver of motor vehicle 105 has to decide, before the approach of second motor vehicle 205, whether he will leave the previously traveled traffic lane 225 towards the left or towards the right, in order to make room for rescue lane 235. Device 100 installed onboard motor vehicle 105, from FIG. 1, supports the driver in this, in that it provides him with an action instruction which has been compared to vehicles 210 in the direct or the farther surroundings of motor vehicle 105. It is thereby prevented that emergency lane 235 changes more frequently than necessary between lanes 220, 225 and 230, it being ensured at the same time that the action instruction determined is oriented to the local possibilities of motor vehicle 105, particularly that there is a physical possibility of following the action instruction.

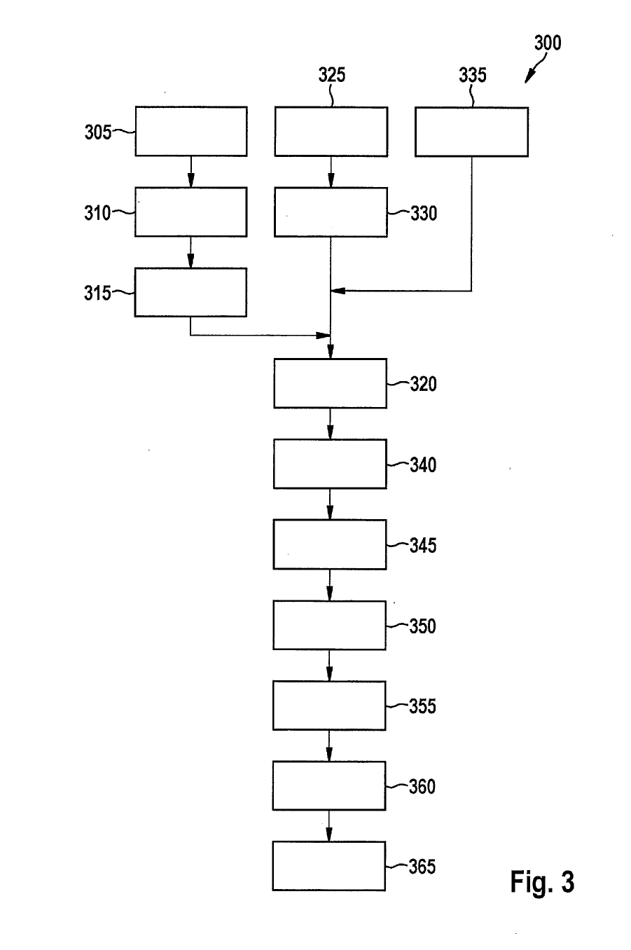

FIG. 3 shows a flow chart of a method 300 to be carried out on processing device 110 of device 100 onboard motor vehicle 105 of FIGS. 1 and 2. Several variants of method 300 are described, of which not all steps are necessarily required, the remaining steps also being able to be put into another sequence in a meaningful way, as one skilled in the art will recognize without any problem.

Method 300 begins in a step 305, in which a message is received using second interface 120, which points out slow-moving traffic or one that is becoming a traffic jam, in the area of motor vehicle 105. In a subsequent step 310, the position of motor vehicle 105 is determined using positioning device 125. In a step 315, with the aid of the message received and the determined position or information of motion of motor vehicle 105, it is determined whether motor vehicle 105 is affected by the traffic situation of the situation received. In a step 320, it is then determined that motor vehicle 105 is located in a region of a building up or an already existing traffic jam.

Alternatively or in addition to steps 305 to 315, the surroundings of motor vehicle 105 may also be scanned, in particular, using a speed sensor, an inertial sensor, a yaw rate sensor, a distance sensor, radar, a lidar sensor or a camera or other imaging device. The scanned data are correlated with one another and evaluated in a step 330, and the presence of a traffic jam in order to determine the presence of a traffic jam in the area of motor vehicle 105. Step 320 then follows, which was described above.

In still another alternative or additional specific embodiment, in a step 335 an input may be recorded by a driver or other passenger onboard motor vehicle 105, which also sets method 300 into step 320.

The entire determination of steps 305 to 335, as to whether motor vehicle 105 is located in the area of a traffic jam is not necessarily required, but some of the actions carried out within the scope of the steps described may also be useful for the following steps.

In an optional step 320, the approach of second motor vehicle 205 having special authorization is determined. This determination may take place using a message received via second interface 120, in an optical manner, acoustically or based on a driver input. In one variant, the approach of second motor vehicle 205 is not captured, but a general requirement is captured for forming emergency lane 235.

In a step 345, additional data, particularly from the close range of motor vehicle 105 is scanned. For this, in particular a radar sensor, a lidar sensor, a camera or parking sensors may be used. Thereafter, based on the scanned information, a local driving situation of motor vehicle 105 is determined. The local driving situation relates less to road 215, on which motor vehicle 105 is traveling, than to surrounding motor vehicles 210 and perhaps 205 as well as people, animals or objects, in case any are present, in the area of motor vehicle 105. The scanned information may particularly include the kind that is collected to support a parking process of motor vehicle 105.

In a step 355, an action request is provided from the information determined, which is suitable for moving motor vehicle 105 in such a way that emergency lane 235 is able to be formed.

In a step 360, the action request determined is compared to motor vehicles 210 in the direct or closer range of motor vehicle 105. In an alternative specific embodiment, steps 355 and 360 are swapped, so that the determined local driving situation, or rather, the information it is based on, is exchanged with the other motor vehicles 210, so as to provide the action request only subsequently. In each case, the result is an action request which has been coordinated with planned or already performed actions of the surrounding motor vehicles 210. Using the example of FIG. 2, it may thus be prevented that emergency lane 235 includes all too frequent lane changes.

In a last step 365, the action request is output, particularly using operating device 130. In one variant, individual systems of motor vehicle 105, especially drive motor 135, steering actuator 140 or brake system 145 may also be activated, so as to implement the action instruction. This implementation may include obtaining the agreement of the driver of motor vehicle 105. In addition or alternatively, the active influencing of motor vehicle 105 by the driver may be withdrawn or changed.

1-10. (canceled)

11. A method for supporting a driver of a first motor vehicle, the method comprising:
scanning a surroundings of the first motor vehicle;
determining an action instruction to the driver of the first motor vehicle to avoid getting in the way of a second motor vehicle that has special authorization; and
outputting the action instruction to the driver of the first motor vehicle;
wherein the determining includes comparing the action instruction to additional motor vehicles within the region of the first motor vehicle.

12. The method of claim 11, wherein the action instruction includes a formation of a special traffic lane for the second motor vehicle.

13. The method of claim 11, further comprising:
receiving a digital message which relates to the approach of the second motor vehicle.

14. The method of claim 11, further comprising:
detecting a threatening or existing traffic jam situation in the area of the first motor vehicle.

15. The method of claim 11, further comprising:
actively influencing a direction control or motion control of the first motor vehicle to implement or to support the action instruction.

16. The method of claim 11, further comprising:
scanning a close range of the first motor vehicle; and
determining a local driving situation based on the scanning and an adaptation of the action instruction to the determined driving situation.

17. A computer readable medium having a computer program, which is executable by a processor, comprising:
a program code arrangement having program code for supporting a driver of a first motor vehicle, by performing the following:
scanning a surroundings of the first motor vehicle;
determining an action instruction to the driver of the first motor vehicle to avoid getting in the way of a second motor vehicle that has special authorization; and
outputting the action instruction to the driver of the first motor vehicle;
wherein the determining includes comparing the action instruction to additional motor vehicles within the region of the first motor vehicle.

18. A device for supporting a driver of a first motor vehicle, comprising:
a scanning device to scan a surroundings of the first motor vehicle;
a processing device to determine an action instruction to the driver of the first motor vehicle to avoid getting in the way of a second motor vehicle that has special authorization;
a data interface to compare the action instruction to additional motor vehicles within the region of the first motor vehicle; and
an output device to output the action instruction to the driver of the first motor vehicle.

19. The device of claim 18, wherein the processing device includes a portable device that is removable from the first motor vehicle.

20. The device of claim 18, further comprising:
a receiving device for receiving data from a merger of processing devices not defined in greater detail.
